(19) United States
(12) Patent Application Publication
(10) Pub. No.: US 2017/0297348 A1
(43) Pub. Date: Oct. 19, 2017

(54) DRYER WITH A FLOW VALVE

(71) Applicant: David E Smith, (US)

(72) Inventor: David E Smith, (US)

(21) Appl. No.: 15/513,985

(22) PCT Filed: Sep. 23, 2014
(86) PCT No.: PCT/US2014/056918

§ 371 Date: Mar. 23, 2017

(51) Int. Cl. B41J 11/00; F26B 21/10; F26B 13/10; F26B 23/04; F26B 3/04

(52) U.S. Cl. CPC B41J 11/0015; F26B 23/04; F26B 3/04; F26B 13/10; F26B 21/10

(57) ABSTRACT

A heater assembly is disclosed. The heater assembly has a frame that has a first and a second opening. There is a heater element located in the first opening. A flow valve is mounted to the frame and movable from a first position to a second position. In the first position, the flow valve blocks airflow through the first opening. In the second position, the flow valve blocks airflow through the second opening. When the flow valve is between the first and second position the flow valve blocks at least some airflow through the first opening and blocks at least some airflow through the second opening.

### BACKGROUND

Inkjet printers are printers that eject printing fluids onto media from a plurality of nozzles of one or more printheads. The printheads can be thermal inkjet printhead, piezo electric printhead or the like. Printing fluid is any fluid deposited onto media to create an image, for example a pre-conditioner, gloss, a curing agent, colored inks, grey ink, black ink, metallic ink, optimizers and the lice. Inkjet inks can be water based inks, solvent based inks or the like.

Some inkjet printers dry the media after depositing the printing fluid. This can increase the speed the printer can print at and reduce image quality problems such as smudging of wet ink. Some pages may require more energy to dry than other pages. The difference in energy required from page to page may be due to different image densities, different page coverage, the amount of pre-conditioners or gloss used and the like.

### BRIEF DESCRIPTION OF THE DRAWINGS

FIG. 1 is an isometric side view of an example heater assembly 100 for a dryer.

FIG. 2A is a front view of the example heating assembly with the flow valve in the first position.

FIG. 2B is a front view of the example heating assembly with the flow valve between the first and second position.

FIG. 2C is a front view of the example heating assembly with the flow valve in the second position.

FIG. 3 is a front view of an example heating assembly with the flow valve removed for clarity.

FIG. 4 is an example plot of resistance vs. temperature for a positive temperature coefficient (PTC) heating element.

FIG. 5 is a block diagram of an example dryer.

FIG. 6 is an example low chart for controlling a dryer.

FIG. 7 is a side view of an example printer.

FIG. 8A is a top view of an example flow valve with the movable input duct in the first position.

FIG. BC is a top view of an example flow valve with the movable input duct between the first position and the second position.

FIG. 8C is a top view of an example flow valve with the movable input duct in the second position.

### DETAILED DESCRIPTION

Inkjet printers may print a variety of different pages in a single print job. Some pages may contain just a few lines of text. Some pages may contain graphics or images embedded in the text. Other pages may contain full page images. Each type of page may require a different amount of energy to properly dry the printing fluid deposited onto the media. To properly dry a page the energy supplied by the dryer should evaporate most of the fluid from the page without overheating the media or wasting energy on a fully dried page.

Many inkjet printers dry the media by forcing heated air against the media. One way to vary the energy hitting the media is to vary the temperature of the heated air. The air temperature is varied by changing the power to the heating element such that the heating element heats up or cools down. Another way to change the amount of energy supplied by the dryer is to change the airflow rate. The airflow rate is changed by varying the speed of the fan that forces the air against the media. In some cases both the air temperature and air speed is varied.

Changing the temperature of the air by adjusting the temperature of the heating element has a number of problems. One of the problems is the slow response time the heating element has to changes in power. In general the heating element can heat up quicker than it can cool down. In either case, heating up or cooling down, the change in temperature of the heating element is slow compared to the speed of the printer. Another problem is the variation in the power required to run the dryer. The power supply is sized to support the maximum power to the dryer. When the dryer is naming at less than maximum power, the power supply nay be running at a lower efficiency. Varying the airspeed through the dryer has similar problems.

In one example the temperature of the air is controlled by using a flow valve that changes the ratio of airflow between a heating duct and a bypass duct. The heating duct contains a heating element and the bypass duct is not heated. The ratio of air is changed by adjusting the flow valve that controls the amount of airflow into the two ducts. To increase the air temperature at the outlet of the dryer more of the total airflow is directed through the heating duct and less of the total airflow is sent through the bypass duct. To decrease the air temperature at the outlet of the dryer, less of the total airflow is directed through the heating duct and more of the total airflow is sent through the bypass duct.

Because the temperature of the air is controlled by the ratio of air passing through the heating duct and the bypass duct, the output air temperature can be changed more quickly than the temperature of the heating element can be changed. In addition the air temperature can be varied between the ambient air temperature and near the maximum temperature of the heating element. Because the air temperature is varied using the flow valve, a constant temperature heating element may be used, for example a positive temperature coefficient (PTC) ceramic heating element. In one example, the total airflow through the dryer remains essentially constant.

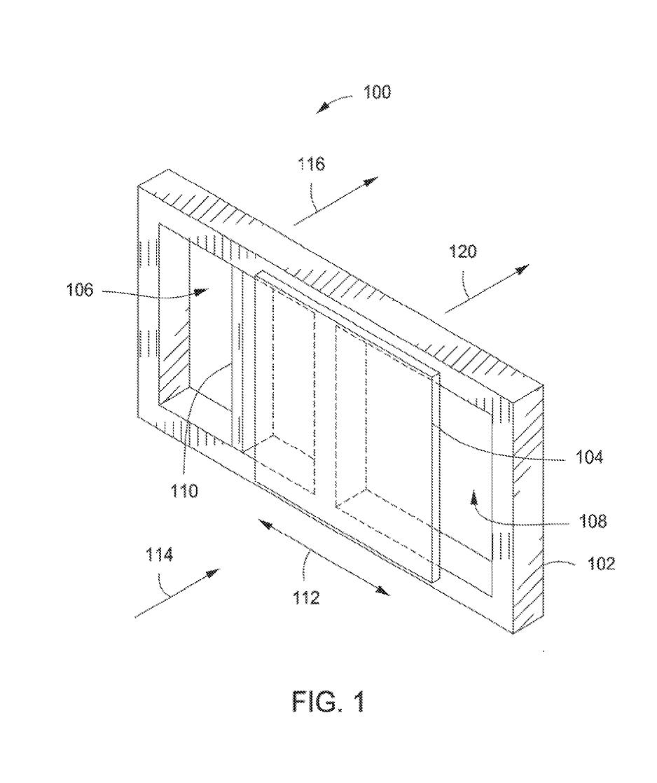

FIG. 1 is an isometric side view of an example heater assembly 100 for a dryer. Heater assembly comprises a frame 102, a flow valve 104 and a heating element 110. Frame 102 forms two openings (106 and 108) that pass through the frame. In this application an opening that passes through the frame of the heater assembly may be known as an opening, a duct, an air passageway or the like. The heating assembly may also include a motor and drive system to move the flow valve, but these elements are not shown for clarity.

An air passageway that increases the temperature of the air passing through it will be known as the heating duct. An air passageway that does not increase the temperature of the air passing through it will be known as the bypass duct. The opening 106 on the left side of the frame has the heating element 110 positioned in it. Therefore in this example this opening 106 is the heating duct. The other opening 108 on the right side of the frame does not have a heating element located in the opening. Therefore in this example this opening 108 is the bypass duct.

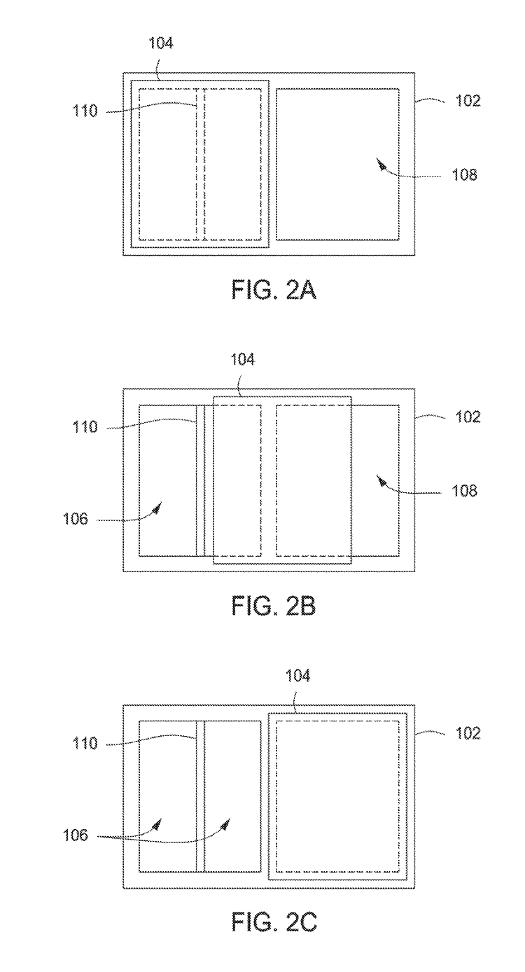

Flow valve 104 is mounted to frame 102 and can move between a first position and a second position along axis 112. In this example the flow valve is a door that slides between the two positions. FIG. 2A is a front view of the example heating assembly with the flow valve in the first position. In the first position the flow valve blocks airflow through the heating duct (opening 106). FIG. 2B is a front view of the example heating assembly with the flow valve between the first and second position. When the flow valve is between the first position and the second position (see FIG. 2B) the flow valve blocks some airflow through the heating duct (opening 106) and blocks some airflow through the bypass duct (opening 108). FIG. 2C is a front view of the example heating assembly with the flow valve in the second position. In the second position the flow valve blocks airflow through the bypass duct (opening 108).

In operation, air is drawn or forced from an inlet side of the frame (as shown by arrow 114 in FIG. 1), through the heating assembly, and into an outlet side of the heating assembly (as shown by arrows 116 and 120 in FIG. 1). The ratio of the air flowing through the heating duct and the bypass duct is controlled by the position of flow valve 104. In some example, the resistance to airflow in the heating duct may be equal to the resistance to airflow in the bypass duct. This creates a constant output airflow independent of the position of flow control valve 104. In this application airflows are considered equal when the airflow in one duct is within +/−5% of the airflow in the other duct.

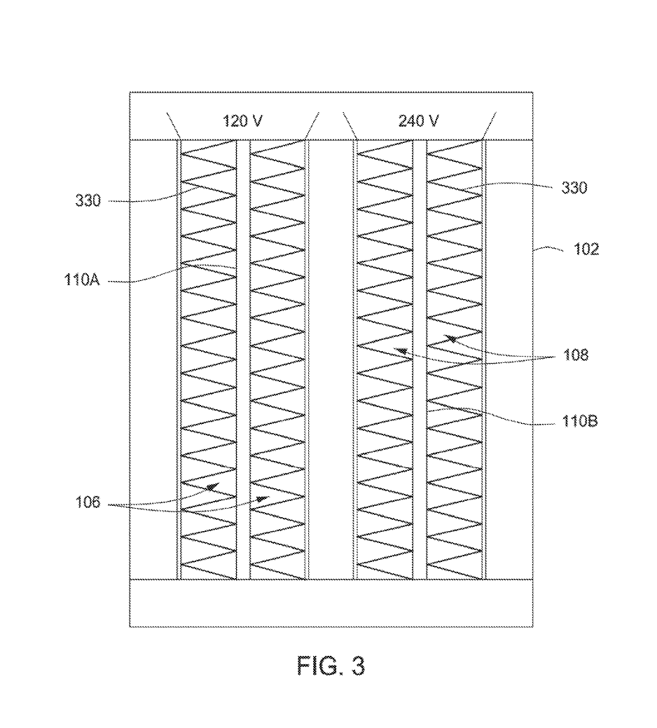

In one example, the resistance to airflow in the heating duct is made equal to the resistance to airflow in the bypass duct by having a heating element in both openings. Only one of the two heating elements will be used at any given time. FIG. 3 is a front view of an example heating assembly with the flow valve removed for clarity. The heating assembly comprises a frame 102, a first heating element 110A, a second heating element 110B and serpentine metal electrodes 330.

Frame 102 may be fabricated from an insulting material and forms two openings 106 and 108 having approximately the same size. Heating element 110A is in the let hand opening and operates at 120 volts. Heating element 110B is in the right hand opening and operates at 240 volts. Both heating elements are sandwiched between serpentine metal electrodes 330. When the dryer is used in countries that support a 120 volt electoral system, heating element 110A is used to dry media. When the dryer is used in countries that support a 240 volt electoral system, heating element 110B it used to dry media. A switch set for the appropriate type of electrical system will connect the AC main voltage to the appropriate heating element. When using the heating element 110A to dry media, opening 106 is considered the heating duct and opening 108 is considered the bypass duct.

The two heating elements (110A and 110B) are the same size and shape. The serpentine metal electrodes 330 are also the same between the two openings (106 and 108). This produces the same resistance to airflow between the two openings. In other examples when there is only one heating element, the resistance to airflow in the heating duct may be made equal to the resistance to airflow in the bypass duct by adjusting the relative six of the openings, adding features into the bypass duct that match the she and shape of the heating element or the like.

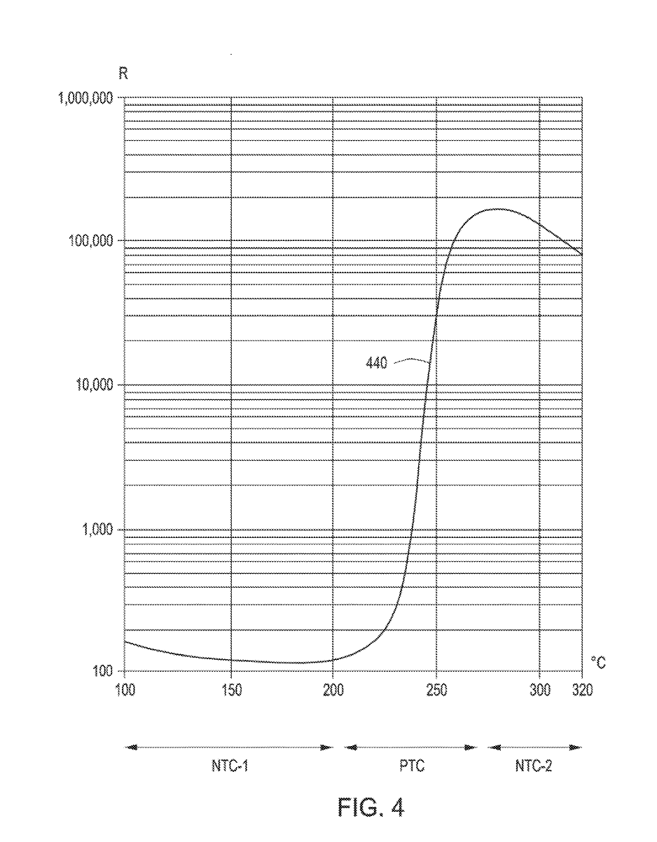

In some examples a positive temperature coefficient (PTC) ceramic heating element is used as the heating element in the heating assembly. FIG. 4 is an example plot of resistance vs. temperate for a PTC heating element. The Vertical axis is resistance using a log scale. The horizontal axis is the temperature of the heating element. Curve 440 is the plot of resistance vs. temperature for an example PTC heating element. The curve 440 has three regions: NTC-1, PTC and NTC-2.

The first region (NTC-1) is a region where the resistance of the heating element decreases with increasing temperature (a negative temperature coefficient region). This region typically is from room temperature up to a critical temperature of approximately 200 degrees C. It is possible to vary the temperature of the heating element in this range of temperatures by varying the amount of power to the heating element. As the temperature of the heating element increases to the critical temperature the heating element enters the second region PTC.

In this region (PTC) the resistance of the heating element increases dramatically in response to small changes in temperature of the heating element (the positive temperature coefficient region). In this self-limiting region the temperature of the heating element is relatively constant and cannot be easily varied. This region typically starts at 200 degrees C. and ends around 280 degrees C. At approximately 280 degree C. and above the heating element enters the last region NTC-2. In this region the resistance of the heating element once again decreases with increasing temperature (the second negative temperature coefficient region). This is considered a thermal runaway region and is typically avoided. During normal operation the temperature of the heating element is kept in the PTC region.

In other examples a nichrome heating element may be used in the heating assembly. In one example the nichrome heating element may be controlled to a constant temperature. In another example the temperature of the nichrome heating element nay be varied as part of the temperature control servo in addition to controlling the position of the flow valve.

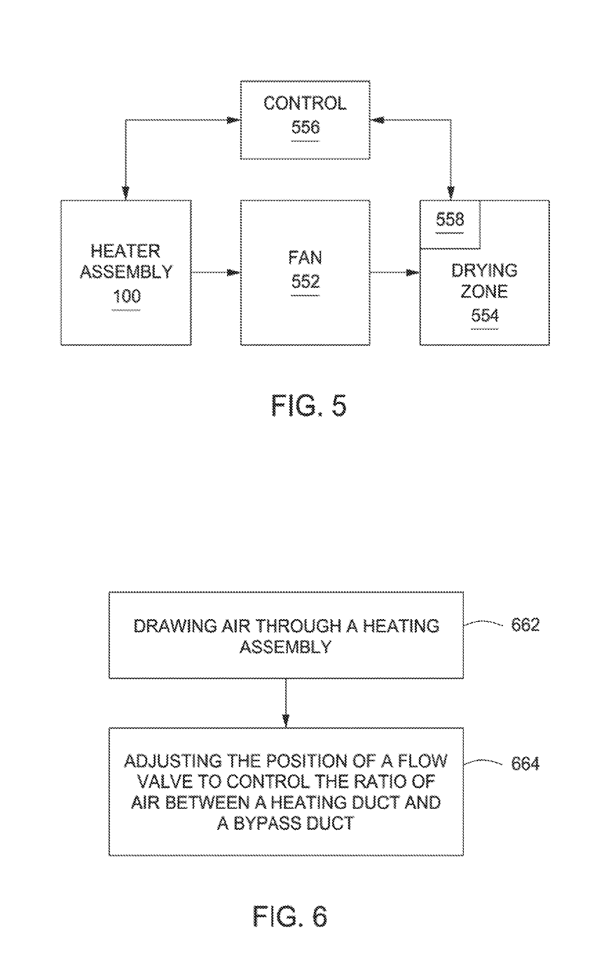

FIG. 5 is a block diagram of an example dryer. The dryer comprises a heater assembly 100, a fan 552, a drying zone 554 and a controller 556. The heater assemble may be the heater assembly shown in FIG. 1. The heater assembly 100 has an input area that allows air to be drawn though the heater assembly into an output area. The output area is coupled to the fan 552 such that the fan can draw air from the input area into the output area. The fan is coupled to a drying zone such that the fan draws air from the output area of the heating assembly and forces the air into the drying zone. A temperature sensor 558 is located in the drying zone.

In this example the controller 556 is coupled to the temperature sensor and to the heating assembly. The controller adjusts the position of the flow valve in the heater assembly to adjust the air temperature in the drying zone to a desired temperature. The desired temperature may be dependent on the type of page in the drying zone. In this example the fan speed may not be varied but may be kept at a constant speed. In another example the controller may also be coupled to the fan and may adjust the fan speed, in addition to the position of the flow valve, to control the air temperature in the drying zone.

The controller 556 may also control the power to the heating element inside the heater assembly. In some examples the controller may simply turn the power to the heating element on and off. In this example the heating element will typically be a PTC heating element. In other examples, the controller may be used to more actively control the temperature of the heating element. In some examples a PTC heating element may be powered on without airflow (i.e. with all the air flowing through the bypass duct or with the fan turned off). This may allow a very fast dryer warm-up.

The controller comprises at least one processor. The processor may comprise a central processing unit (CPU), a micro-processor, an application specific integrated circuit (ASIC), or a combination of these devices. The controller may also comprise memory.

The memory may comprise volatile memory, non-volatile memory, and a storage device. Memory is a non-transitory computer readable medium. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices

The dryer may have computer executable code, typically called firmware, stored in the memory. The firmware is stored as computer readable instructions in the non-transitory computer readable medium (i.e. the memory). The processor generally retrieves and executes the instructions stored in the non-transitory computer-readable median to operate the dryer and to execute functions. In one example, the processor executes code that controls the air temperature in the drying zone to a desired temperature by changing the position of a flow valve.

FIG. 6 is an example flow chart for controlling a dryer, for example the dryer in FIG. 5. At block 662 air is drawn through a heating assembly, for example the heating assembly of FIG. 1. At block 664 the position of a flow valve in the heating assembly is adjusted to control the ratio of air flowing through a heating duct and a bypass duct. In some examples the flow valve is movable between a first position and a second position. When in the first position, the flow valve may completely block airflow through the heating duct. When in the second position, the flow valve may completely block airflow through the bypass duct. When the flow valve is between the first and second position the flow valve blocks at least some airflow through the heating duct and blocks at least some airflow through the bypass duct. In other examples the flow valve may not completely block the airflow through the heating duct when in the first position. This allows at least some airflow through the heating duct and may help prevent the heating element from overheating and entering the thermal runaway region.

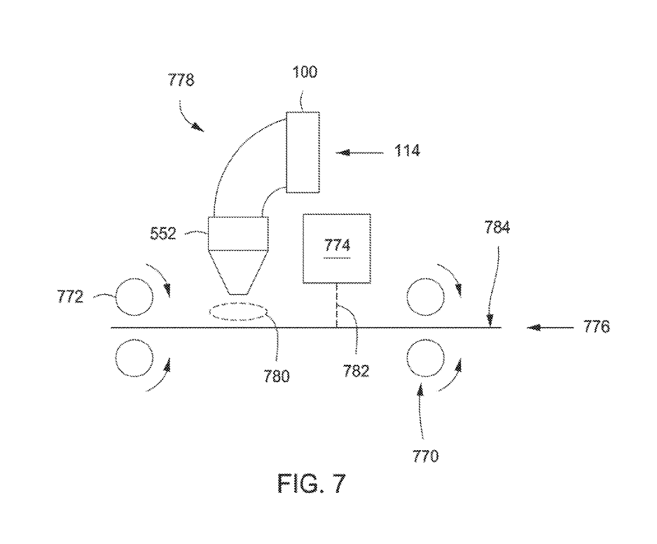

FIG. 7 is a side view of an example printer. Printer comprises two pitch rollers 770, two take-up rollers 772, a print engine 774 and a dryer 778, for example the dryer in FIG. 5. The printer may also include a media source, an output tray, a control panel, a controller, a drive train to move the media and the like, but these items are not shown for clarity. A media path runs from between the two pinch rollers 770, underneath the print engine 774, underneath the dryer 778 and between the two take-up rollers 772. A sheet of media 784 is shown in the media path. The media feed direction, also known as the printing direction, is shown by arrow 776. In other examples the media may be in a continuous roll. As the media travels underneath the print engine 778 printing fluids 782 are deposited onto the media from the print engine. As the media travels underneath the dryer 778, the media passes through a drying zone 780 where media is dried.

Dryer 778 comprises a heating assembly 100 and a fan 552 (the controller is not shown and may be integrated as part of the printer controller). The output area of the heating assembly 100 is coupled to the fan by ductwork. Additional ductwork is attached to the fan output to focus the airflow into the drying zone 780. In operation air is drawn into the input area of the heating assembly by the fan as shown by arrow 114. The air is brought to a desired temperature by changing the ratio of airflow between the heating duct and the bypass duct by moving the flow valve. The air is then forced into the drying zone where the media is dried.

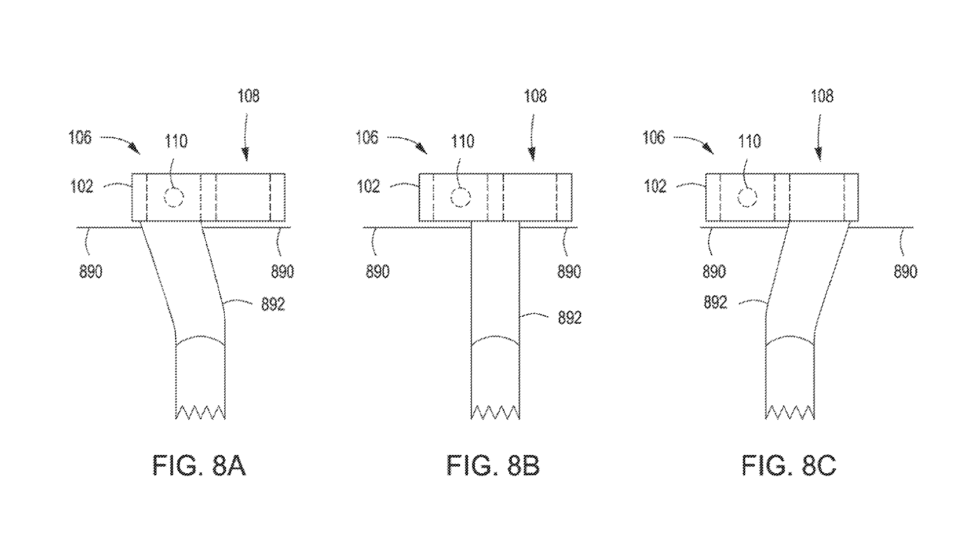

In the descriptions above, the flow valve was shown as a door that can move between two positions. The flow valve is not limited to a sliding door and can take other forms. FIGS. 8A, 8B and 8C show an alternate form of a low valve. In this example flow valve takes the form of a movable input duct with side flanges. FIG. 8A shows the movable input duct in the first position. In the first position the movable input duct is aligned with the first opening 106 in frame 102. The heating element 10 is located in the first opening 106 so this opening is the heating duct. The movable input duct has side flanges 890 that block airflow through the opening that is not aligned with the movable input duct.

FIG. 8C shows the movable input duct in the second position. In the second position the movable input duct is aligned with the second opening 108 in frame 102. The second opening 106 does not contain a heating element so this opening is the bypass duct. FIG. 8B shows the movable input duct between the first position and the second position. In this position air can flow through both the heating duct and the bypass duct.

What is claimed is:

1. A dryer, comprising:
a heater assembly having a frame that has a first and a second opening;
a first heater element located in the first opening;
a flow valve coupled to the frame and movable from a first position to a second position, wherein when in the first position, the flow valve blocks airflow through the first opening, when in the second position, the flow valve blocks airflow through the second opening, when the flow valve is between the first and second position the flow valve blocks at least some airflow though the first opening and blocks at least some airflow through the second opening.

2. The dryer of claim 1, wherein a sum of an airflow through the first opening and an airflow through the second opening remains essentially constant independent of the flow valve location.

3. The dryer of claim 1, wherein, during operation, the first heater element is kept at a constant temperature.

4. The dryer of claim 1, wherein the first heater element is a positive temperature coefficient (PTC) ceramic heater.

5. The dryer of claim 1, wherein a resistance to airflow through the first opening is equal to a resistance to airflow through the second opening.

6. The dryer of claim 1, further comprising:
a second heating element in the second opening, where the first heater element is a 120V heater element and the second heater element is a 240V heater element and only one of the first and second heater elements is operated at a time.

7. The dryer of claim 1, further comprising:
a fan having an inlet and an outlet, the inlet coupled to the heater assembly such that air is drawn through the heater assembly, the outlet adjacent to a drying one of a printer;
a temperature sensor adjacent to the fan outlet to measure the air temperature of air at the fan outlet;
a controller coupled to the flow valve and to the temperature sensor to adjust the position of the flow valve to control the air temperature at the fan outlet.

8. The dryer of claim 1, wherein the flow valve is a door that is slideably mounted to the frame.

9. The dryer of claim 1, wherein when the flow valve is in the first position at least some air passes through the first opening.

10. A method of drying media, comprising:
drawing air through a heating assembly and forcing the air into a drying zone, the heating assembly having a heating duct and a bypass duct;
adjusting a flow valve to control a ratio of airflow between the heating duct and the bypass duct to control an output air temperature, wherein when in a first position, the flow valve blocks airflow through the heating duct, when in a second position, the flow valve blocks airflow through the bypass duct, when the flow valve is between the first and second position the flow valve blocks at least some airflow through the heating duct and blocks at least some airflow through the bypass duct.

11. The method of claim 10, wherein a heater element in the heating duct is operated at a constant temperature.

12. The method of claim 11, wherein the heater element in the heating duct is a nichrome heater.

13. The method of claim 10, wherein a resistance to airflow through the heating duct is equal to a resistance to airflow through the bypass duct.

14. The dryer of claim 10, wherein the flow valve is an input duct that is slideably mounted to the heating assembly.

15. A printer, comprising:
a drying zone where heated air is directed onto media;
a heater assembly having frame that has a first and a second opening;
a heater element located in the first opening;
a flow valve mounted to the frame and movable from a first position to a second position, wherein when in the first position, the flow valve blocks airflow through the first opening, when in the second position, the flow valve blocks airflow through the second opening, when the flow valve is between the first and second position the flow valve blocks at least some airflow through the fast opening and blocks at least some airflow through the second opening
wherein a sum of an airflow through the first opening and an airflow through the second opening remains essentially constant independent of the flow valve location;
a fan having an inlet and an outlet, the inlet coupled to the heater assembly such that air is drawn through the heater assembly, the outlet coupled to the drying zone;
a temperature sensor adjacent the fan outlet to measure the air temperature of air at the fan outlet;
a controller coupled to the flow valve and to the temperature sensor to adjust the position of the flow valve to control the air temperature at the fan outlet.
